(19) United States
(12) Patent Application Publication
(10) Pub. No.: US 2022/0156590 A1
(43) Pub. Date: May 19, 2022

(54) ARTIFICIAL INTELLIGENCE SYSTEM AND ARTIFICIAL NEURAL NETWORK LEARNING METHOD THEREOF

(71) Applicant: ELECTRONICS AND TELECOMMUNICATIONS RESEARCH INSTITUTE, Daejeon (KR)

(72) Inventors: Sung Eun KIM, Daejeon (KR); Tae Wook KANG, Daejeon (KR); Hyuk KIM, Daejeon (KR); Kwang IL OH, Daejeon (KR)

(21) Appl. No.: 17/459,950

(22) Filed: Aug. 27, 2021

(30) Foreign Application Priority Data
Nov. 18, 2020 (KR) 10-2020-0154623
Apr. 22, 2021 (KR) 10-2021-0052507

(51) Int. Cl. G06N 3/08; G06N 3/04

(52) U.S. Cl. CPC G06N 3/082; G06N 3/049

(57) ABSTRACT

Disclosed is a method for learning an artificial neural network in a synapse of an artificial intelligence system including generating, by an input neuron of the artificial intelligence system, a first input signal, generating, by the input neuron, a second input signal after a predetermined time, generating, by an output neuron of the artificial intelligence system, an output signal in response to the first input signal and the second input signal that are generated by the input neuron, and adjusting, by the synapse of the artificial intelligence system, connection strength of the artificial neural network based on a temporal order of the first input signal and the second input signal that are generated by the input neuron.

### CROSS-REFERENCE TO RELATED APPLICATIONS

This application claims priority under 35 U.S.C. § 119 to Korean Patent Application Nos. 10-2020-0154623 filed on Nov. 18, 2020, and 10-2021-0052507 filed on Apr. 22, 2021, in the Korean Intellectual Property Office, the disclosures of which are incorporated by reference herein in their entireties.

### BACKGROUND

Embodiments of the present disclosure described herein relate to an artificial intelligence system, and more particularly, relate to an artificial intelligence system that processes dynamic data in a form of a time series, and an artificial neural network learning method.

There is a growing interest in an artificial intelligence technology that processes information by applying a human thinking process, a human inferring process, and a human learning process to an electronic device. Technologies for processing information by mimicking neurons and synapses included in a human brain are also being developed. While changing the coupling strength of synapses, the artificial intelligence technology that has been currently developed is learning external data. The artificial intelligence technologies are being applied to various fields such as risk recognition, security, autonomous driving, smart management, and the like.

In the meantime, research on a spike neural network method is being actively conducted to reduce the power consumption of the artificial intelligence technology. This greatly contributes to the low power of the whole AI system through a method of delivering a signal through a spike signal during a short time.

A conventional artificial intelligence technology is optimized to process static data. Nowadays, most of artificial intelligence technologies focus on analyzing motionless pictures or photos at a level of number recognition in handwritten data, such as MNIST, or object recognition in photo data, such as CIFAR-10. However, pieces of data that are actually present outside are most of dynamic data in a form of a time series that are continuously changed over time. To process the dynamic data, there is a need for a separate learning and inference method different from the conventional learning method.

There is a prior art disclosed as Korean Registered Patent Publication No. 10-1512370 (NEUROMORPHIC SYSTEM OPERATING METHOD FOR THE SAME)

### SUMMARY

Embodiments of the present disclosure provide an artificial intelligence system that processes dynamic data in a form of a time series, and an artificial neural network learning method.

According to an embodiment, a method for learning an artificial neural network in a synapse of an artificial intelligence system includes generating, by an input neuron of the artificial intelligence system, a first input signal, generating, by the input neuron, a second input signal after a predetermined time, generating, by an output neuron of the artificial intelligence system, an output signal in response to the first input signal and the second input signal that are generated by the input neuron, and adjusting, by the synapse of the artificial intelligence system, connection strength of the artificial neural network based on a temporal order of the first input signal and the second input signal that are generated by the input neuron.

In an embodiment, the method may include generating, by the output neuron, the output signal depending on the adjusted connection strength of the artificial neural network when the connection strength of the artificial neural network is adjusted by the synapse of the artificial intelligence system and then the first input signal and the second input signal are generated by the input neuron in a temporal order.

According to an embodiment, a method for learning an artificial neural network in a synapse of an artificial intelligence system includes generating, by an input neuron of the artificial intelligence system, a first dynamic signal continuously, generating, by the input neuron, a second dynamic signal continuously, generating, by an output neuron of the artificial intelligence system, an output signal in response to the first input signal and the second input signal that are generated by the input neuron, and adjusting, by the synapse of the artificial intelligence system, connection strength of the artificial neural network based on a repeated pattern of the first dynamic signal and the second dynamic signal that are generated by the input neuron.

In an embodiment, the method further includes generating, by the output neuron, the output signal depending on the adjusted connection strength of the artificial neural network when the connection strength of the artificial neural network is adjusted by the synapse of the artificial intelligence system and then the first dynamic signal and the second dynamic signal are generated by the input neuron based on the repeated pattern.

In an embodiment, the output neuron generating the output signal based on the repeated pattern may be excluded from a suppression pathway such that the output neuron is not affected by generation of another output signal.

According to an embodiment, an artificial intelligence system includes an input neuron that generates a first input signal and a second input signal, an output neuron that generates an output signal in response to the generation of the first input signal and the second input signal, and a synapse that adjusts connection strength of an artificial neural network between the output signal of the output neuron and the first input signal and the second input signal of the input neuron, based on a generation time order of the first input signal and the second input signal and based on a repeated pattern of a same signal. Each of the first input signal and the second input signal is a dynamic signal generated continuously.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an artificial intelligence system, according to an embodiment of the present disclosure.

FIGS. 2 and 3 are block diagrams illustrating an example of a learning method of the artificial intelligence system shown in FIG. 1.

FIG. 4 is a block diagram illustrating another example of a learning method of the artificial intelligence system shown in FIG. 1.

FIGS. 5 and 6 are block diagrams for describing an artificial neural network learning method of an artificial intelligence system, according to an embodiment of the present disclosure.

FIG. 7 is a block diagram for describing an artificial neural network learning method of an artificial intelligence system, according to an embodiment of the present disclosure.

FIGS. 8 and 9 are flowcharts illustrating an artificial neural network learning method of an artificial intelligence system, according to an embodiment of the present disclosure.

### DETAILED DESCRIPTION

Hereinafter, embodiments of the present disclosure may be described in detail and clearly to such an extent that an ordinary one in the art easily implements the present disclosure.

Data entered into an artificial intelligence system includes static data, such as a photo or picture, and dynamic data changed continuously. A conventional artificial intelligence system is mainly optimized to process static data signals. However, various signals that are actually present outside may be pieces of dynamic data changed continuously.

For the artificial intelligence system to process dynamic data, a current static data learning method has limitations. There is a need for a learning method suitable to process dynamic data that is changed continuously. The artificial intelligence system according to an embodiment of the present disclosure may provide a method for adjusting the connection strength of a neural network by updating the weight of a synapse based on the relative occurrence order and difference in occurrence time of an input signal and learning about a separate repetition pattern.

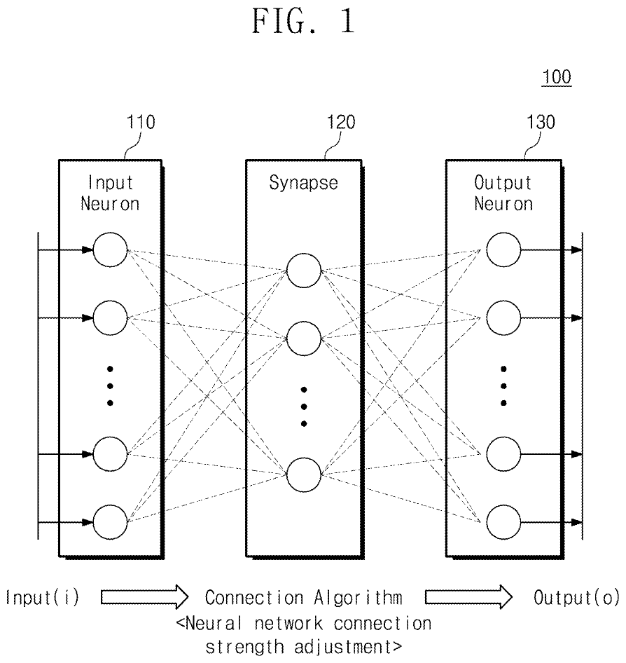

FIG. 1 is a block diagram illustrating an artificial intelligence system, according to an embodiment of the present disclosure. Referring to FIG. 1, an artificial intelligence system 100 includes an input neuron 110, a synapse 120, and an output neuron 130. The input neuron 110 and the output neuron 130 are connected through a connection algorithm of the synapse 120. A connection network (indicated by dotted lines) between the input neuron 110 and the output neuron 130, which are connected through a synapse connection algorithm in FIG. 1, is referred to as an “artificial neural network”.

An input signal (i) entered into the input neuron 110 of the artificial intelligence system 100 may be learned to be provided to an output signal (o) of the output neuron 130 through the connection algorithm of the synapse 120. The connection algorithm of the synapse 120 (hereinafter referred to as a “synapse connection algorithm”) may be implemented to make the connection strength of the artificial neural network stronger depending on the relative generation order or a generation time difference of the input signal (i). The synapse 120 may have a single-layer structure or a multi-layer structure. The synapse 120 may adjust the connection strength of an artificial neural network through the single-layer structure or the multi-layer structure.

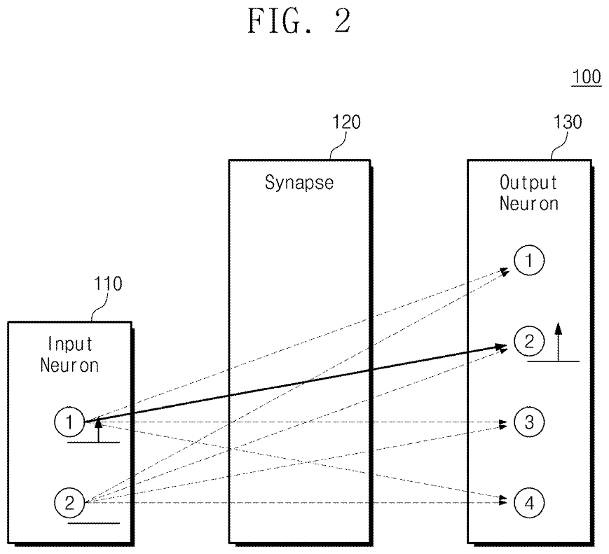

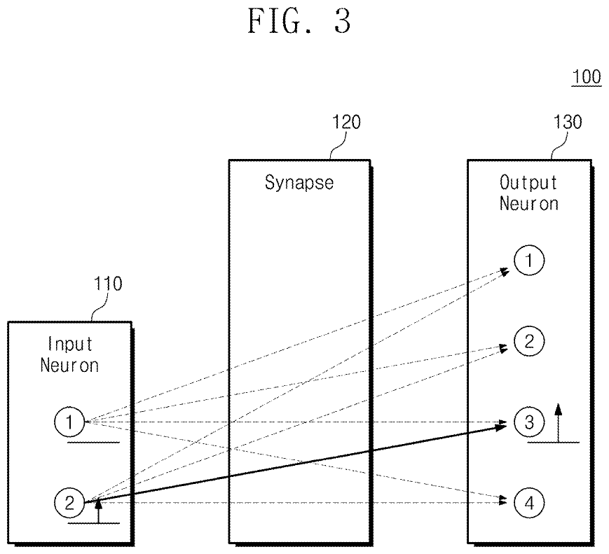

FIGS. 2 and 3 are block diagrams illustrating an example of a learning method of the artificial intelligence system shown in FIG. 1. The artificial intelligence system 100 may adjust the connection strength of an artificial neural network based on a time difference between the input signal (i) and the output signal (o) of a neural network.

Referring to FIG. 2, it is assumed that a first input signal is generated by the input neuron 110 of the artificial intelligence system 100, and thus a second output signal is generated by the output neuron 130. As seen from the arrow of the thick solid line in FIG. 2, a synapse connection algorithm of the artificial intelligence system 100 may strengthen the connection strength of the artificial neural network connecting between the first input signal and the second output signal.

Referring to FIG. 3, it is assumed that a second input signal is generated by the input neuron 110 of the artificial intelligence system 100, and thus a third output signal is generated by the output neuron 130. As seen from the arrow of the thick solid line in FIG. 3, the synapse connection algorithm of the artificial intelligence system 100 may strengthen the connection strength of the artificial neural network connecting between the second input signal and the third output signal.

When the first input signal is generated by the input neuron 110 later, the artificial intelligence system 100 that is learned as shown in FIGS. 2 and 3 induces the output neuron 130 to generate the second output signal. Moreover, when the second input signal is generated by the input neuron 110, the artificial intelligence system 100 induces the output neuron 130 to generate the third output signal.

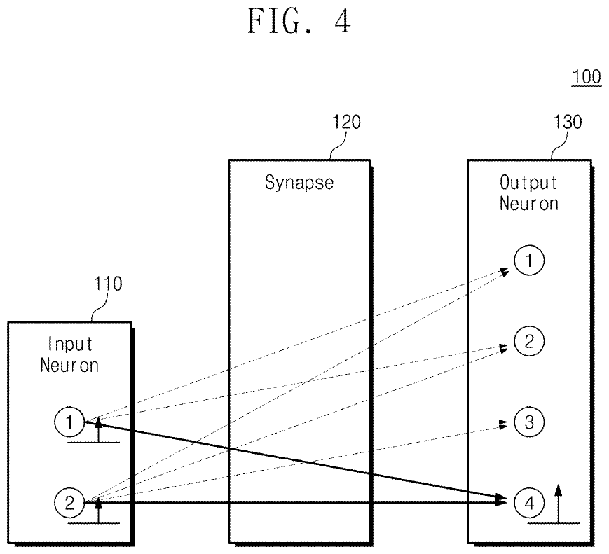

FIG. 4 is a block diagram illustrating another example of a learning method of the artificial intelligence system shown in FIG. 1. The artificial intelligence system 100 illustrates a method in which the artificial intelligence system 100 adjusts the connection strength of an artificial neural network in a situation, where a plurality of signals are entered, based on the learning method of the artificial neural network learned in FIGS. 2 and 3.

Referring to FIG. 4, it is assumed that a first input signal and a second input signal are generated by the input neuron 110 of the artificial intelligence system 100 simultaneously or non-simultaneously, and thus a fourth output signal is generated by the output neuron 130. As seen from the arrow of the thick solid line in FIG. 4, a synapse connection algorithm of the artificial intelligence system 100 may partially strengthen the connection strength of the artificial neural network connecting between the first input signal and the fourth output signal, and may partially strengthen the connection strength of the artificial neural network connecting between the second input signal and the fourth output signal.

When the first input signal and the second input signal is generated by the input neuron 110 later, the artificial intelligence system 100 that is learned as shown in FIG. 4 induces the output neuron 130 to generate the fourth output signal rather than the second output signal or the third output signal.

In the example of FIG. 4, the artificial intelligence system 100 considers the temporal order of the first input signal and the second input signal in the input neuron 110. However, the artificial intelligence system 100 according to an embodiment of the present disclosure may strongly adjust the connection strength of the artificial neural network in consideration of the temporal order of signals entered by the input neuron 110.

When an input signal is dynamic data, the temporal order of input signals is very important. When a dynamic input signal is not reflected to a synapse connection algorithm of the artificial intelligence system 100, much pieces of information may be inevitably lost. The artificial intelligence system 100 according to an embodiment of the present disclosure may maximally reduce information loss by adjusting the connection strength of the artificial neural network in consideration of a time difference between input signals.

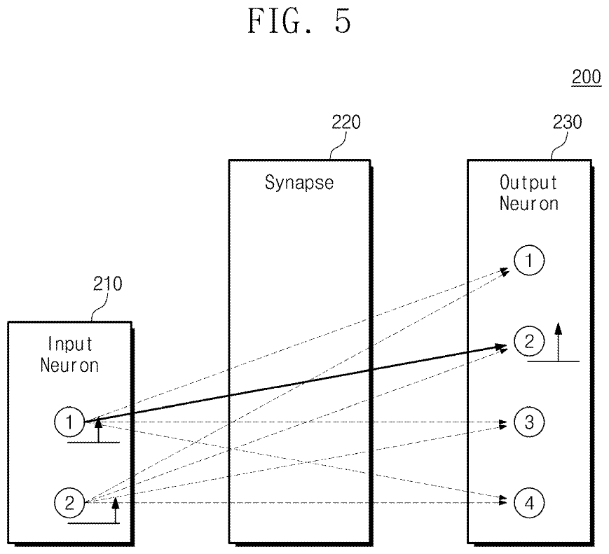

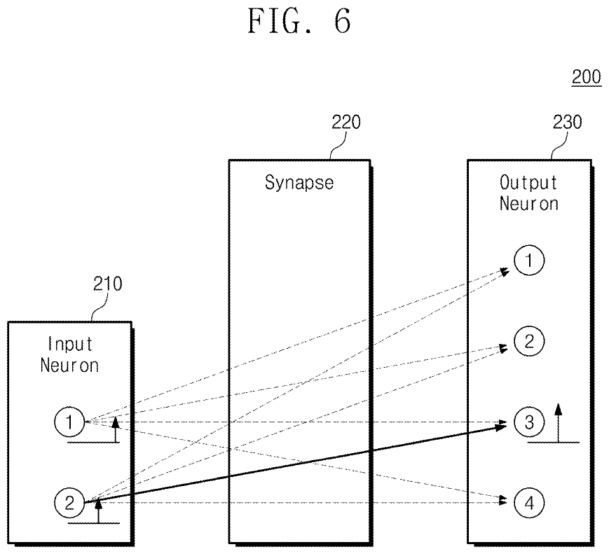

FIGS. 5 and 6 are block diagrams for describing an artificial neural network learning method of an artificial intelligence system, according to an embodiment of the present disclosure. Referring to FIGS. 5 and 6, an artificial intelligence system 200 includes an input neuron 210, a synapse 220, and an output neuron 230. The input neuron 210 and the output neuron 230 are connected through a connection algorithm of the synapse 220.

The artificial intelligence system 200 according to an embodiment of the present disclosure may adjust the connection strength of an artificial neural network in consideration of a relative time difference between a plurality of input signals entered into the input neuron 210 or a signal time difference generated from one input signal. That is, when dynamic data is entered into the input neuron 210, the artificial intelligence system 200 according to an embodiment of the present disclosure adjusts the connection strength of the artificial neural network of the output neuron 230 in consideration of a temporal order of input signals.

Referring to FIG. 5, it is assumed that a second input signal is generated by the input neuron 210 of the artificial intelligence system 200 after a first input signal is generated first by the input neuron 210 of the artificial intelligence system 200, and thus a second output signal is generated by the output neuron 230. As seen from the arrow of the thick solid line in FIG. 5, the synapse connection algorithm of the artificial intelligence system 200 may strengthen the connection strength of an artificial neural network connecting between the first input signal and the second output signal.

For example, it is assumed that the probability that the second output signal is generated in response to the generation of the first input signal is 30%, and the probability that the second output signal is generated in response to the generation of the second input signal is 30%. When the first input signal and the second input signal are not generated simultaneously, the probability that the second output signal is generated may be 90% by strengthening the connection strength of the artificial neural network between the second output signal and the first and second input signals. That is, when the first input signal is generated and then the second input signal is generated within a specific time, the probability that the second output signal is generated in response to the second input signal may be increased from 30% to 60%. Accordingly, when the second input signal is generated after the first input signal is generated, the probability that the second output signal is generated may be 90%.

When the first input signal is generated by the input neuron 210 and then the second input signal is generated by the input neuron 210 later, the artificial intelligence system 200 that is learned as shown in FIG. 5 induces the output neuron 230 to generate the second output signal. The artificial intelligence system 200 may learn the synapse connection algorithm so as to make the strength of the artificial neural network between the first input signal and the second output signal stronger in consideration of the relative time difference between the first input signal and the second input signal.

Referring to FIG. 6, it is assumed that, the first input signal is generated by the input neuron 210 of the artificial intelligence system 200 after the second input signal is generated first, and thus a third output signal is generated by the output neuron 230. As seen from the arrow of the thick solid line in FIG. 6, the synapse connection algorithm of the artificial intelligence system 200 may strengthen the connection strength of an artificial neural network connecting between the second input signal and the third output signal.

As in the above-described example, when the second input signal is generated and then the first input signal is generated within a specific time, the probability that the third output signal is generated in response to the first input signal may be increased from 30% to 60%. Accordingly, when the first input signal is generated after the second input signal is generated, the probability that the third output signal is generated may be 90%.

When the second input signal is generated by the input neuron 210 and then the first input signal is generated by the input neuron 210 later, the artificial intelligence system 200 that is learned as shown in FIG. 6 induces the output neuron 230 to generate the third output signal. The artificial intelligence system 200 may learn the synapse connection algorithm so as to make the strength of the artificial neural network between the second input signal and the third output signal stronger in consideration of the relative time difference between the first input signal and the second input signal.

The artificial intelligence system 200 according to an embodiment of the present disclosure may reflect a lot of information to the artificial intelligence system 200 by adjusting the connection strength of the artificial neural network in consideration of the order of input signals generated by the input neuron 210. This makes the configuration of the whole system simpler and allows the whole system to have lower power consumption when the system is implemented in hardware in the future.

In the meantime, as well as considering the temporal order of input signals, the artificial intelligence system 200 according to an embodiment of the present disclosure may be designed to respond to a plurality of time-series dynamic signals by separately providing neurons for time series patterns.

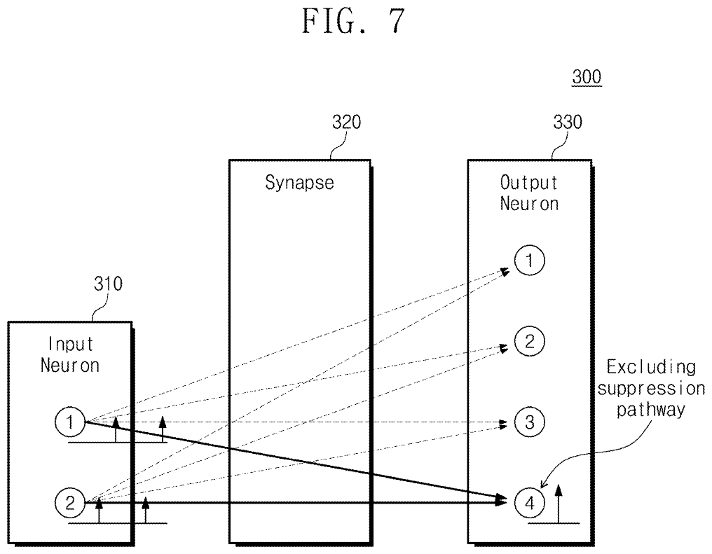

FIG. 7 is a block diagram for describing an artificial neural network learning method of an artificial intelligence system, according to an embodiment of the present disclosure. Referring to FIG. 7, an artificial intelligence system 300 includes an input neuron 310, a synapse 320, and an output neuron 330. The input neuron 310 and the output neuron 330 are connected through a connection algorithm of the synapse 320.

When a dynamic signal is continuously generated by the input neuron 310, the artificial intelligence system 300 shown in FIG. 7 may learn a synapse connection algorithm to make the strength of the artificial neural network between the output signals of the output neuron 330 stronger.

Referring to FIG. 7, it is assumed that the first dynamic signal is continuously generated by the input neuron 310 of the artificial intelligence system 300 after a second dynamic signal is continuously generated by the input neuron 310 of the artificial intelligence system 300, and thus a fourth output signal is generated by the output neuron 330. As seen from the arrow of the thick solid line in FIG. 7, a synapse connection algorithm of the artificial intelligence system 300 may strengthen the connection strength of the artificial neural network connecting between the first dynamic signal and the fourth output signal, and the connection strength of the artificial neural network connecting between the second dynamic signal and the fourth output signal.

When the second dynamic signal is continuously generated by the input neuron 310 and then the first dynamic signal is continuously generated by the input neuron 310 later, the artificial intelligence system 300 that is learned as shown in FIG. 7 induces the output neuron 330 to generate the fourth output signal. The artificial intelligence system 300 may learn the synapse connection algorithm so as to make the strength of the artificial neural network between the input neuron 310 and the output neuron 330 stronger in consideration of the continuity of the first dynamic signal and the second dynamic signal.

When an input signal of a dynamic data pattern continuously is entered into the input neuron 310, the artificial intelligence system 300 shown in FIG. 7 strengthens the connection strength of the artificial neural network with a specific output signal of the output neuron 330. In this way, the artificial intelligence system 300 may perform learning so as to recognize that a dynamic signal generation pattern of the input neuron 310 is a new signal. This may be defined as a path different from that of the output neuron of a conventional artificial intelligence system. In the conventional artificial intelligence system, when a signal is generated by an output neuron, the output neuron is affected by a suppression pathway for lowering a membrane value of another neuron. However, when the pattern of a dynamic signal is continuously entered according to the artificial intelligence system 300, the output neuron 330 may not be affected by the suppression pathway for generating an output signal. Accordingly, the artificial intelligence system 300 according to an embodiment of the present disclosure may be designed to have the greatest meaning when a reference value is exceeded.

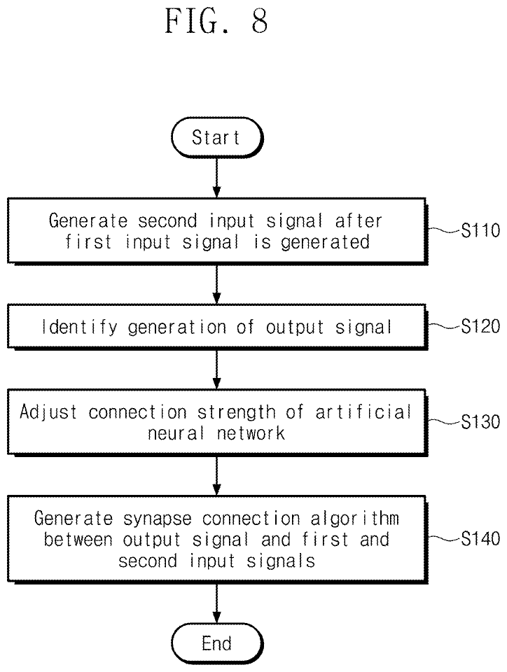

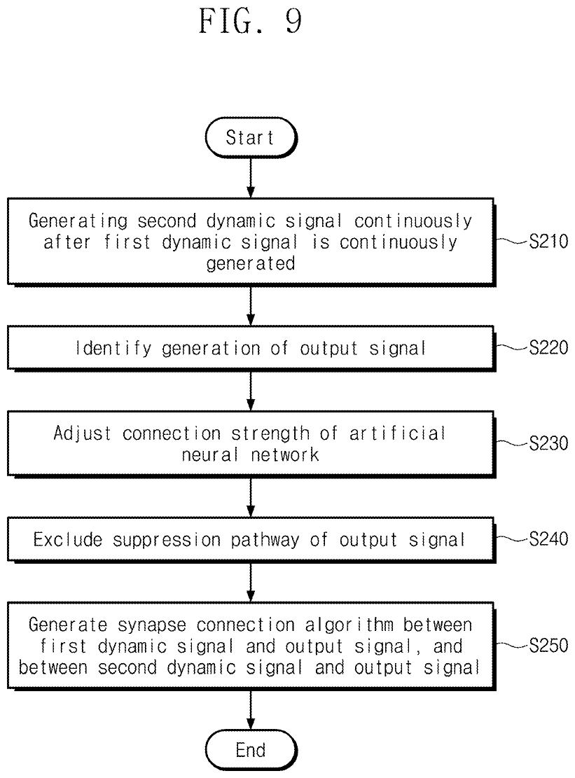

FIGS. 8 and 9 are flowcharts illustrating an artificial neural network learning method of an artificial intelligence system, according to an embodiment of the present disclosure. An artificial intelligence system according to an embodiment of the present disclosure may adjust the connection strength of an artificial neural network in consideration of the temporal order (refer to FIG. 8) and the continuity (refer to FIG. 9) of input signals, when dynamic data is entered into an input neuron.

Referring to FIG. 8, in operation S110, a second input signal is generated after the first input signal is generated by the input neuron of the artificial intelligence system. In operation S120, an output signal is generated by an output neuron as a result of the first and second input signals.

In operation S130, a synapse connection algorithm of an artificial intelligence system adjusts the connection strength of the artificial neural network connecting between the first input signal and the output signal. For example, it is assumed that the probability that an output signal is generated in response to the generation of the first input signal is 30%, and the probability that the output signal is generated in response to the generation of the second input signal is 30%. When the second input signal is generated after the first input signal, the probability that the output signal is generated in response to the second input signal may be increased from 30% to 60%. Accordingly, when the second input signal is generated after the first input signal is generated, the probability that the output signal is generated may be 90%.

In operation S140, the artificial intelligence system generates a synapse connection algorithm between the output signal and the first and second input signals. Later, when the first input signal is generated by the input neuron and then the second input signal is generated by the input neuron, the artificial intelligence system generates the learned output signal in consideration of the relative time difference between the first input signal and the second input signal.

Referring to FIG. 9, in operation S210, after the first dynamic signal is continuously generated by the input neuron of the artificial intelligence system, a second dynamic signal is continuously generated. In operation S220, as a result of the continuous generation of the first and second dynamic signals, an output signal is generated by the output neuron. In operation S230, the synapse connection algorithm of an artificial intelligence system adjusts the connection strength of the artificial neural network connecting between a dynamic signal and an output signal. In operation S240, the artificial intelligence system excludes a suppression pathway of the output signal in consideration of the repetitive continuity of a plurality of dynamic signals. In operation S250, the artificial intelligence system generates a synapse connection algorithm between the first dynamic signal and the output signal, and between the second dynamic signal and the output signal. When a plurality of continuous dynamic signals are generated by the input neuron later, the artificial intelligence system generates the learned output signal in consideration of the relative time difference and continuity of dynamic signals.

As such, the artificial intelligence system according to an embodiment of the present disclosure may maximally reduce information loss by generating an output signal in consideration of the temporal order of input signals and the continuity of a pattern.

The above-mentioned description refers to embodiments for implementing the scope of the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

As compared with a conventional artificial intelligence method through the analysis of static data, an artificial intelligence system according to an embodiment of the present disclosure may be designed with a simpler structure and may analyze dynamic data with little power. According to an embodiment of the present disclosure, it is possible to implement an ultra-small and high-efficiency artificial intelligence system capable of processing dynamic data.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method for learning an artificial neural network in a synapse of an artificial intelligence system, the method comprising:
generating, by an input neuron of the artificial intelligence system, a first input signal;
generating, by the input neuron, a second input signal after a predetermined time;
generating, by an output neuron of the artificial intelligence system, an output signal in response to the first input signal and the second input signal that are generated by the input neuron; and
adjusting, by the synapse of the artificial intelligence system, connection strength of the artificial neural network based on a temporal order of the first input signal and the second input signal that are generated by the input neuron.

2. The method of claim 1, further comprising:
when the connection strength of the artificial neural network is adjusted by the synapse of the artificial intelligence system and then the first input signal and the second input signal are generated by the input neuron in the temporal order, generating, by the output neuron, the output signal depending on the adjusted connection strength of the artificial neural network.

3. The method of claim 1, wherein the synapse has a single-layer structure or a multi-layer structure.

4. A method for learning an artificial neural network in a synapse of an artificial intelligence system, the method comprising:
generating, by an input neuron of the artificial intelligence system, a first dynamic signal continuously;
generating, by the input neuron, a second dynamic signal continuously;
generating, by an output neuron of the artificial intelligence system, an output signal in response to the first input signal and the second input signal that are generated by the input neuron; and
adjusting, by the synapse of the artificial intelligence system, connection strength of the artificial neural network based on a repeated pattern of the first dynamic signal and the second dynamic signal that are generated by the input neuron.

5. The method of claim 4, further comprising:
when the connection strength of the artificial neural network is adjusted by the synapse of the artificial intelligence system and then the first dynamic signal and the second dynamic signal are generated by the input neuron based on the repeated pattern, generating, by the output neuron, the output signal depending on the adjusted connection strength of the artificial neural network.

6. The method of claim 4, wherein the output neuron generating the output signal based on the repeated pattern is excluded from a suppression pathway such that the output neuron is not affected by generation of another output signal.

7. The method of claim 4, wherein the synapse has a single-layer structure or a multi-layer structure.

8. An artificial intelligence system comprising:
an input neuron configured to generate a first input signal and a second input signal;
an output neuron configured to generate an output signal in response to the generation of the first input signal and the second input signal; and
a synapse configured to adjust connection strength of an artificial neural network between the output signal of the output neuron and the first input signal and the second input signal of the input neuron, based on a generation time order of the first input signal and the second input signal and based on a repeated pattern of a same signal.

9. The artificial intelligence system of claim 8, wherein each of the first input signal and the second input signal is a dynamic signal generated continuously.

10. The artificial intelligence system of claim 8, wherein the synapse has a single-layer structure or a multi-layer structure.
